(19) United States
(12) Patent Application Publication
(10) Pub. No.: US 2017/0034322 A1
(43) Pub. Date: Feb. 2, 2017

(54) MOBILE TERMINAL DEVICE

(71) Applicant: Zhengmin Benjamin Pan, L.A., CA (US)

(72) Inventor: Zhengmin Benjamin Pan, L.A., CA (US)

(73) Assignee: AAC Technologies Pte. Ltd.,, Singapore city (SG)

(21) Appl. No.: 15/060,771

(22) Filed: Mar. 4, 2016

(30) Foreign Application Priority Data
Jul. 31, 2015 (CN) 201520572340.1

(51) Int. Cl. H04M 1/03; H04W 88/02

(52) U.S. Cl. CPC H04M 1/03; H04W 88/02

(57) ABSTRACT

A mobile terminal device is provided in the present disclosure. The mobile terminal device includes a display module, a shell and a voice generator. The shell includes a bottom plate and a plurality of sidewalls extending from the bottom plate, one of the sidewalls includes a voice outlet. The voice generator is received in the shell and adjacent to the voice outlet. The voice generator includes a vibrating system and a magnetic system for providing a magnetic gap, the vibrating system includes a membrane and a coil assembly, the coil assembly is received in the magnetic gap and configured for driving the membrane to vibrate and generate audible voice. The audible voice is outputted to the voice outlet in the sidewall along a transmitting direction parallel to the display module.

### FIELD OF THE DISCLOSURE

The present disclosure generally relates to mobile communication technologies, and more particularly, to a mobile terminal device with a voice outlet.

### BACKGROUND

With development of mobile communication technologies, mobile terminal devices such as mobile phones or tablet computers are used more and more widely. Mobile terminal devices normally include voice outlets for outputting audible voice from an inner voice generator such as a receiver, so that users can hear the audible voice to implement voice calls.

In a related mobile terminal device, the voice outlet thereof is formed in a display module; the audible voice is outputted perpendicularly to the display module. However, the voice outlet formed in the display module may impact an integrity and appearance of the display module, and increase assembling complexity and cost of the mobile terminal device.

Therefore, it is desired to provide a new mobile terminal device which can overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is an exploded view of a mobile terminal device according to an embodiment of the present disclosure;

FIG. 2 is an exploded view of a voice generator of the mobile terminal device of FIG. 1.

### DETAILED DESCRIPTION

The present disclosure will be described in detail below with reference to the attached drawings and the embodiment thereof.

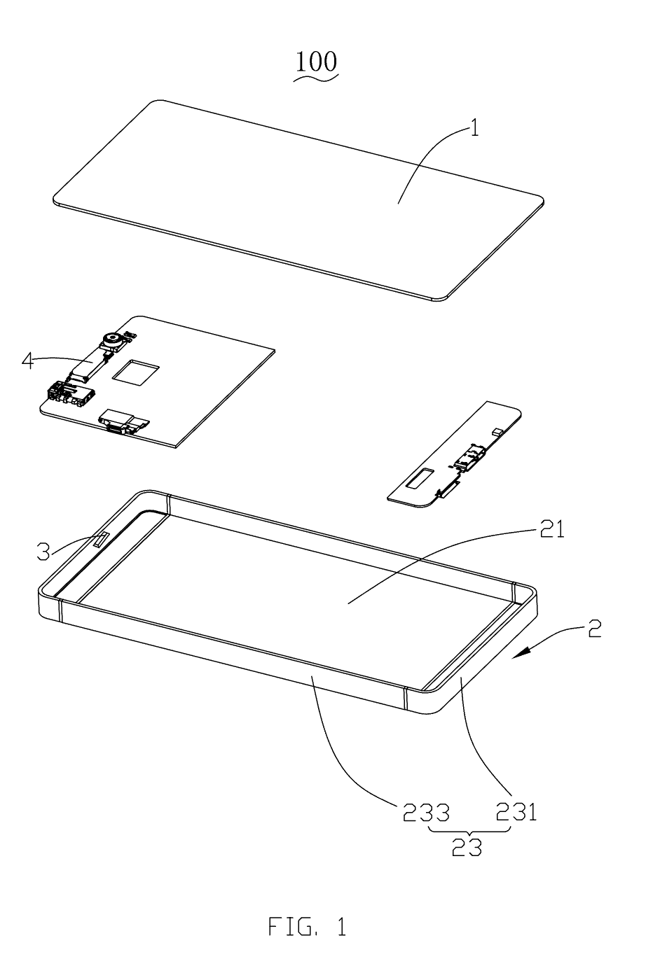

Referring to FIG. 1, a mobile terminal device 100 according to an embodiment of the present disclosure is shown. The mobile terminal device 100 may be a mobile phone, which includes a display module 1, a shell 2 supporting the display module 1 for forming an accommodating space, and a voice generator 4 received in the accommodating space. The display module 1 may be a liquid crystal display (LCD) module for displaying images, texts, and videos for the mobile terminal device 100.

The main shell 2 includes a bottom plate 21 and a plurality of sidewalls 23 extending perpendicularly from the bottom plate 21 to form a box-like structure. For example, the bottom plate 21 may be a rectangular plate with a pair of long edges parallel to each other and a pair of short edges perpendicular to the long edges. The sidewalls 23 includes a pair of first sidewalls 233 extending from the long edges of the bottom plate 21 respectively, and a pair of second sidewalls 231 extending from the short edges of the bottom plate 21 respectively. The second sidewalls 231 correspond to an upper portion and a lower portion of the mobile terminal device 1 respectively.

The voice generator 4 may be located adjacent to the second sidewall 232 corresponding to the upper portion of the mobile terminal device 1; the above-mentioned second sidewall 232 includes a voice outlet 3 adjacent to the voice generator 4, and in particular, the voice generator 4 faces the voice outlet 3 so that audible voice generated by the voice generator 4 can be directly outputted from the voice outlet 3.

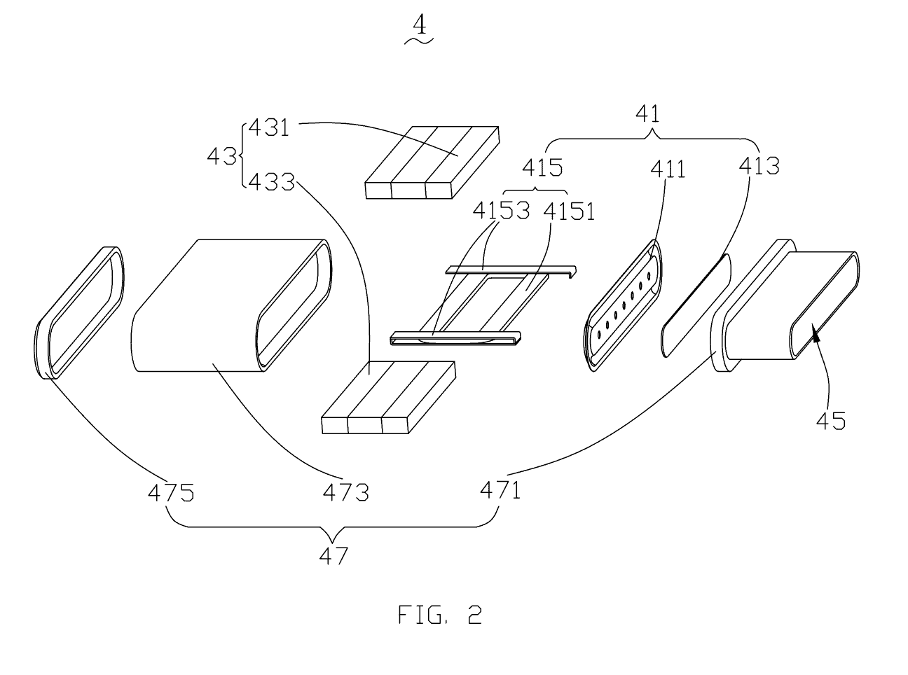

Referring also to FIG. 2, the voice generator 4 may be a receiver for converting electric audio signal into the audible voice. The voice generator 4 includes a vibrating system 41, a magnetic system 43 and a package member 47. The vibrating system 41 and the magnetic system 43 are received in the package member 47, and the package member includes a voice output hole 45, which is communicated with the voice outlet 3 in the second sidewall 231.

Specifically, the vibrating system 41 includes a membrane 411, a dome 413 attached on the membrane 411, and a coil assembly 415 for driving the membrane 411 to vibrate. The membrane 411 is positioned in a plane perpendicular to the display module 1, and faces the voice output hole 45; the coil assembly 415 is connected to the membrane 411 and is perpendicular to the membrane 411.

In the present embodiment, the coil assembly 415 includes a coil 4151 and a coil support 4153 for supporting the coil 4151. The coil support 4153 includes two parallel supporting rims, and two opposite ends of the coil 4151 are arranged on the supporting rims respectively. The coil support 4153 is further connected to the membrane 411; the coil support 4153 and the dome 413 are respectively located at two opposite surfaces of the membrane 411, and the dome 413 is adjacent to the voice output hole 45.

The magnetic system 43 includes a first magnet 431 and a second magnet 433 opposite to each other to form a magnetic gap. The first magnet 431 and the second magnet 433 are respectively located at two opposite sides of the coil assembly 415 and received in the magnetic gap. The coil 4151 of the coil assembly 415 may be driven to perform reciprocating motion in the magnetic gap and thus can obtain a longer stroke.

The package member 47 may have a hollow structure, and includes a front cover 471, a main cylinder 473 and a rear cover 475. The voice output hole 45 may be formed at the front cover 471, and the front cover 471 is adjacent to the vibrating system 41. The main cylinder 473 is hollow and includes a front opening and a rear opening; the front cover 471 and the rear cover 473 cover the front opening and the rear opening of the main cylinder 473 respectively to form a receiving cavity for receiving the vibration system 41 and the magnetic system 43. In the present embodiment, the front cover 471 and the rear cover 475 may be detachable from the main cylinder 473, and this facilitates component assembly and disassembly in the package member 47.

When the voice generator 4 of the mobile terminal device 1 is in operation, the coil 4151 is driven to perform reciprocating motion in the magnetic gap between the first magnet 431 and the second magnet 433, and the reciprocating motion of the coil 4151 is transferred to the membrane 411 via the coil support 4153. Accordingly, the membrane 411 is driven to vibrate and correspondingly produce audible voice; the audible voice is further outputted to the voice outlet 3 in the shell 2 via the voice output hole 45 along a transmitting direction parallel to the display module 1.

In the mobile terminal device 100 as provided in the present embodiment, the voice outlet 3 is formed in a sidewall 23 of the shell 2 rather than in the display module 1. With this configuration, an integrity and appearance of the display module can be maintained, and this can reduce the assembling complexity and cost of the mobile terminal device 100, and can also improve an acoustic performance of the mobile terminal device 100.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile terminal device, comprising:
a display module;
a shell comprising a bottom plate and a plurality of sidewalls extending from the bottom plate, one of the sidewalls comprising a voice outlet; and
a voice generator received in the shell and adjacent to the voice outlet;
wherein the voice generator comprises a vibrating system and a magnetic system for providing a magnetic gap, the vibrating system comprises a membrane and a coil assembly, the coil assembly is received in the magnetic gap and configured for driving the membrane to vibrate and generate audible voice; the audible voice is outputted to the voice outlet in the sidewall along a transmitting direction parallel to the display module.

2. The mobile terminal device of claim 1, wherein the bottom plate is a rectangular plate comprising two opposite long edges and two opposite short edges, the plurality of sidewalls comprises a pair of first sidewalls extending from the long edges of the bottom plate, and a pair of second sidewalls extending from the short edges of the bottom plate; the voice outlet is formed in one of the second sidewalls.

3. The mobile terminal device of claim 1, wherein the voice generator further comprises a package member for receiving the vibrating system and the magnetic system.

4. The mobile terminal device of claim 3, wherein the package member comprises a voice output hole facing and communicated with the voice outlet in the sidewall.

5. The mobile terminal device of claim 4, wherein the package member comprises a front cover, a main cylinder and a rear cover, the front cover and the rear cover respectively cover a front opening and a rear opening of the main cylinder, and the voice output hole is formed on the front opening.

6. The mobile terminal device of claim 5, wherein the front cover and the rear cover is detachable from the main cylinder.

7. The mobile terminal device of claim 1, wherein the vibrating system further comprises a dome attached on the membrane; the dome and the coil support are located at two opposite surfaces of the membrane respectively.

8. The mobile terminal device of claim 7, wherein the coil assembly comprises a coil and a coil support for supporting the coil.

9. The mobile terminal device of claim 8, wherein the coil support comprises two parallel supporting rims connected to the membrane; two opposite ends of the coil are arranged on the supporting rims respectively.

10. The mobile terminal device of claim 1, wherein the magnetic system comprises a first magnet and a second magnet opposite to each other for forming the magnetic gap.
